(19) United States
(12) Patent Application Publication
(10) Pub. No.: US 2026/0357845 A1
(43) Pub. Date: Nov. 12, 2026

(54) MULTI-PIECE FASTENERS AND METHODS FOR FASTENING

(71) Applicant: HOWMET AEROSPACE INC., Pittsburgh, PA (US)

(72) Inventor: Thomas BRENNETOT, Conflans-Saint-Honorine (FR)

(21) Appl. No.: 19/120,926

(22) PCT Filed: Nov. 29, 2022
(86) PCT No.: PCT/IB2022/000697

§ 371 Date: Apr. 14, 2025

(51) Int. Cl. F16B 37/04; F16B 5/02; F16B 5/04

(52) U.S. Cl. CPC F16B 37/044; F16B 5/02; F16B 5/04

(57) ABSTRACT

A multi-piece fasteners and methods for fastening are provided. A multi-piece fastener can comprise a sleeve and a retainer. The sleeve can comprise an elongate portion defining a longitudinal axis and comprising an inner surface defining a sleeve cavity. The sleeve can further comprise a first ratchet feature which is coupled to the elongate portion. The retainer can comprise a first surface and a second surface extending from the first surface. The second surface can comprise a second ratchet feature configured to engage the first ratchet feature to thereby inhibit the sleeve from moving along the longitudinal axis when a first force applied along the longitudinal axis to the sleeve is less than a predetermined force and enable the sleeve to move along the longitudinal axis when a second force applied to the longitudinal axis to the sleeve is equal to or greater than the predetermined force.

### FIELD OF USE

The present disclosure relates to multi-piece fasteners and methods for fastening.

### BACKGROUND

Vehicle frames, storage racks, solar panel sub-structures, aircraft parts, electrical panels, and other structures can include numerous mechanical fasteners. For example, a mechanical fastener can be installed in a bore of a structural component to secure parts together. Properly installing a mechanical fastener prior to drilling a bore through the structure presents challenges.

### SUMMARY

One non-limiting aspect of the present disclosure is directed to a multi-piece fastener comprising a sleeve and a retainer. The sleeve comprises an elongate portion defining a longitudinal axis and comprising an inner surface defining a sleeve cavity, and a first ratchet feature coupled to the elongate portion. The retainer comprises a first surface and a second surface extending from the first surface and comprising a second ratchet feature. The second ratchet feature is configured to engage the first ratchet feature to thereby inhibit the sleeve from moving along the longitudinal axis when a first force applied along the longitudinal axis to the sleeve is less than a predetermined force. The second ratchet feature also is configured to enable the sleeve to move along the longitudinal axis when a second force applied along the longitudinal axis to the sleeve is equal to or greater than the predetermined force.

Another non-limiting aspect of the present disclosure is directed to a multi-piece fastener comprising a sleeve and a retainer. The sleeve comprises a first sleeve end, a second sleeve end, and an elongate portion extending from the first sleeve end to the second sleeve end and defining a longitudinal axis. The elongate portion comprises an inner surface defining a sleeve cavity and comprising a first portion extending along the longitudinal axis and comprising threads having a root diameter. The inner surface comprises a second portion extending along the longitudinal axis comprising a cylindrical shape defining a first diameter. The first diameter is greater than the root diameter of the threads. The first portion of the inner surface is disposed intermediate the second portion and the first sleeve end.

Yet another non-limiting aspect of the present disclosure is directed to a method for fastening. The method comprises coupling a retainer of a multi-piece fastener to a structure. The multi-piece fastener comprises a sleeve and the retainer. The sleeve comprises an elongate portion defining a longitudinal axis and comprising an inner surface defining a sleeve cavity, and a first ratchet feature coupled to the elongate portion. The retainer comprises a first surface and a second surface extending from the first surface and comprising a second ratchet feature. The second ratchet feature is configured to engage the first ratchet feature. The method comprises forming a bore in the structure after coupling the retainer to the structure, and inserting a pin of the multi-piece fastener through the bore and into the sleeve cavity of the sleeve. The pin engages the inner surface of the sleeve to move the sleeve along the longitudinal axis towards the structure when a force applied to the longitudinal axis is equal to or greater than a predetermined force.

It will be understood that the inventions disclosed and described in this specification are not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a perspective view of a non-limiting embodiment of a multi-piece fastener according to the present disclosure;

FIG. 2 is a cross-sectional side view of the multi-piece fastener of FIG. 1;

FIG. 3 is a exploded view of the multi-piece fastener of FIG. 1;

FIG. 4 is a perspective view of the multi-piece fastener of FIG. 1, shown in a second position;

FIG. 5 is a perspective view of a non-limiting embodiment of a retainer according to the present disclosure;

FIG. 6 is a perspective view of a non-limiting embodiment of a retainer according to the present disclosure;

FIG. 7 is a perspective view of a non-limiting embodiment of a retainer according to the present disclosure;

FIG. 8 is a detail view of area 8 of the multi-piece fastener of FIG. 1;

FIG. 9 is a detail view of area 9 of the multi-piece fastener of FIG. 4;

FIG. 10 is a detail view of area 10 of the multi-piece fastener of FIG. 3;

FIG. 11 a partial cross-sectional view of a non-limiting embodiment of a multi-piece fastener according to the present disclosure and a structure, shown in a first configuration;

FIG. 12 is a partial cross-sectional view of the multi-piece fastener and the structure of FIG. 11, shown in a second configuration;

FIG. 13 is a partial cross-sectional view of the multi-piece fastener and the structure of FIG. 12, shown in a third configuration;

FIG. 14 is a partial cross-sectional view of the multi-piece fastener and the structure of FIG. 13, shown in a fourth configuration;

FIG. 15 is a partial cross-sectional view of the multi-piece fastener and the structure of FIG. 14, shown in a fifth configuration;

FIG. 16 is a partial cross-sectional view of the multi-piece fastener and the structure of FIG. 15, shown in a sixth configuration; and

FIG. 17 is a cross-sectional view of a non-limiting embodiment of a multi-piece fastener according to the present disclosure.

Corresponding reference characters indicate corresponding parts throughout the several views. The exemplifications set out herein illustrate certain non-limiting embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed multi-piece fasteners and methods of fastening. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

As used herein, “at least one of” a list of elements means one of the elements or any combination of two or more of the listed elements. As an example “at least of A, B, and C” means A only; B only; C only; A and B; A and C; B and C; or A, B, and C.

Typically, for assembling together two structural panels, the two panels are properly aligned and then clamped together. The clamped panels are drilled to form a bore through both panels, the clamp is removed, and a nut portion of a fastener is installed on the inner panel, aligned with the bore. After the nut portion is installed, sealant is applied between the panels and a screw is installed through the drilled bore and engaging the nut to hold the panels together. The present inventors have developed multi-piece fasteners that can be installed prior to forming a bore in a structural panel or other element, advantageously enabling more efficient assembly of elements. The present inventors also have developed an associated method of advantageously securing structural panels or other elements with a multi-piece fastener

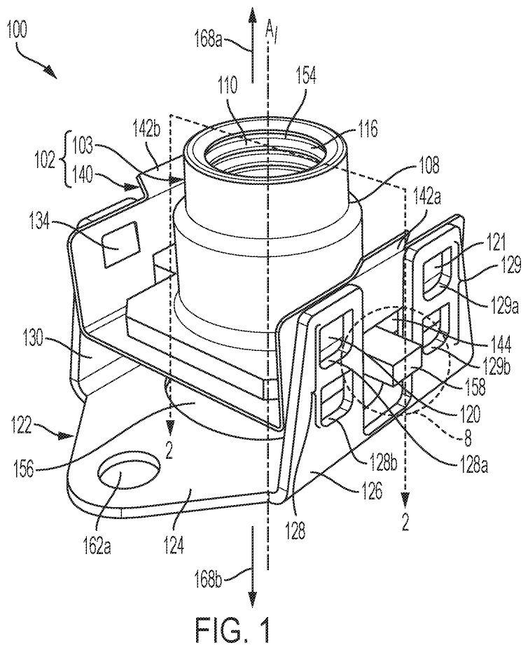

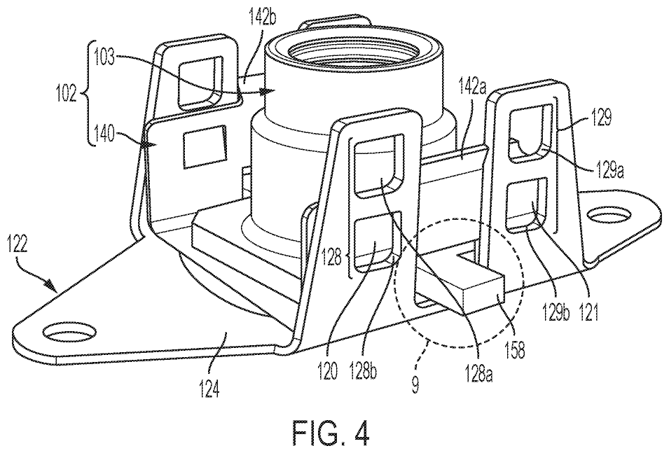

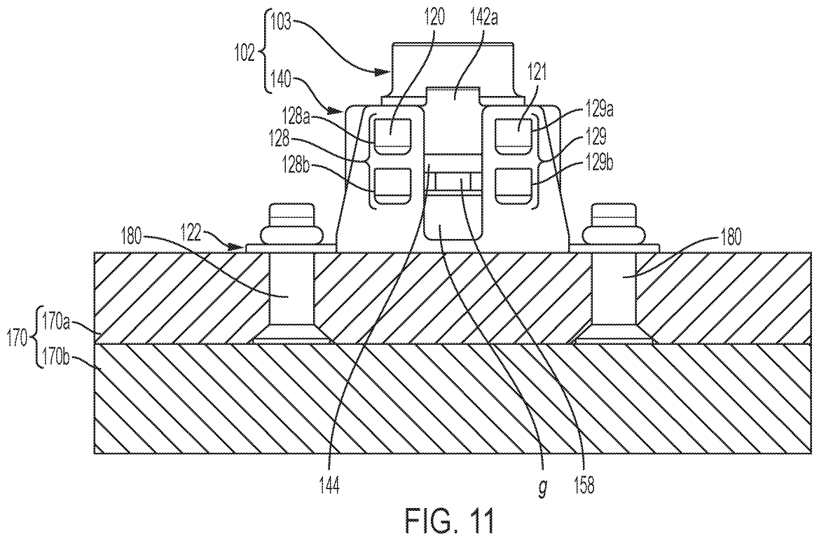

Referring to FIGS. 1-3, a non-limiting embodiment of a multi-piece fastener 100 according to the present disclosure is provided. The multi-piece fastener 100 comprises a sleeve 102 and a retainer 122 configured so that the sleeve 102 can move between a first position relative to the retainer 122 as illustrated in FIG. 1 and a second position relative to the retainer 122 as illustrated in FIG. 4. The retainer 122 is configured to be mounted to a structure, such as, for example, structure 170 as shown in FIG. 11.

With reference to FIGS. 1 and 4, in the second position the sleeve 102 is closer to a first surface 124 of the retainer 122 than when the sleeve 102 is in the first position. The movement of the sleeve 102 allows a gap, g, to be present intermediate the sleeve 102 and a structure (e.g., structure 170 as illustrated in FIG. 11) prior to forming a bore in the structure. The gap, g, provides clearance for a forming tool (e.g., a drill bit, a machining bit, a punch) to create a bore in the structure after installation of the multi-piece fastener 100, while reducing undesired damage to the multi-piece fastener 100.

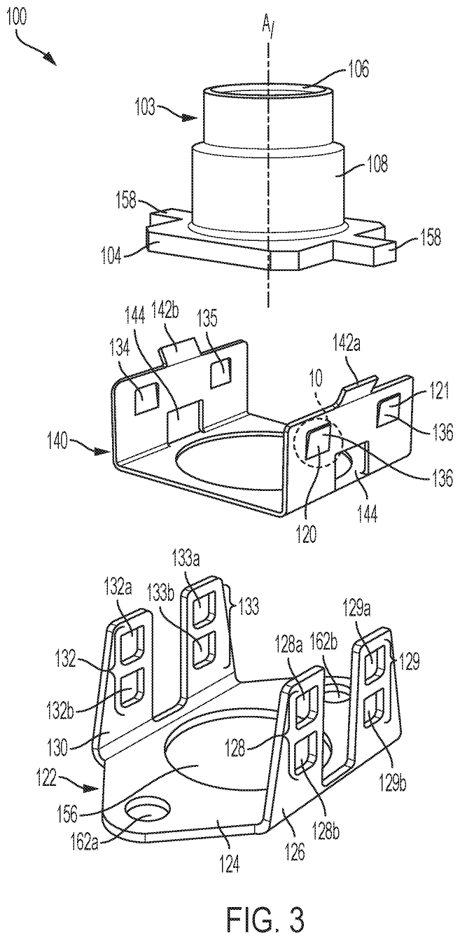

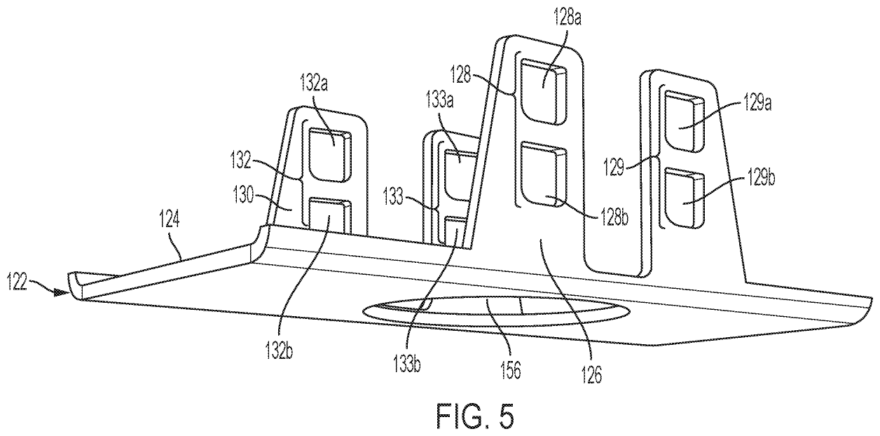

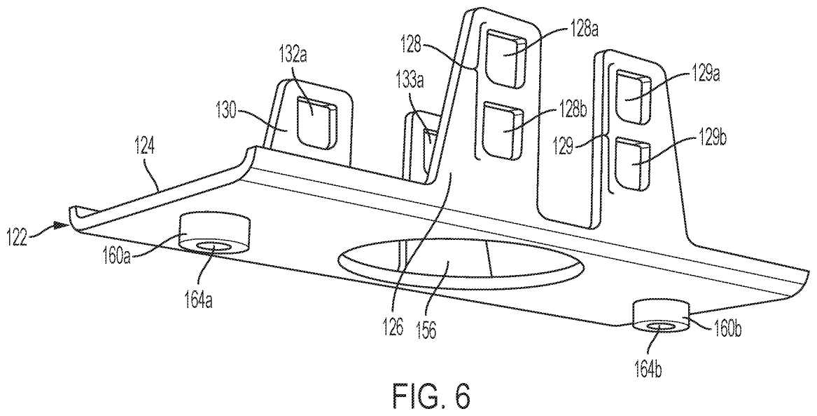

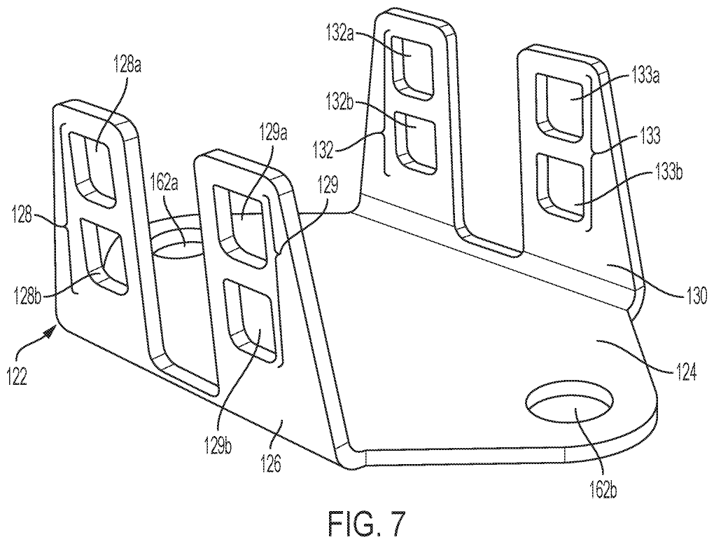

The retainer 122 can be configured to engage or be engaged to a structure and support the sleeve 102. The retainer 122 comprises the first surface 124 that can be configured to couple with a structure by at least one of a fastener (e.g., a rivet, a screw), a pin, and an adhesive. For example, as shown in FIG. 3, the first surface 124 can comprise bores 162a and 162b which can each receive a fastener mechanically attaching the retainer 122 to the structure 170. In various non-limiting embodiments, referring to FIG. 5, the retainer 122 may lack bores 162a, 162b for attaching the retainer 122 to a structure, and instead the retainer 122 can be coupled to a structure using an adhesive. In certain non-limiting embodiments, referring to FIG. 6, the retainer 122 can comprise locating pins 160a and 160b that can be used to position the retainer 122 in a desired location on the structure. In various non-limiting embodiments, referring to FIG. 7, the retainer 122 may not comprise bore 156, and the first surface 124 is a continuous surface from a second surface 126 to a third surface 130. The locating pins 160a and 160b can comprise bores 164a and 164b that receive fasteners to attach the retainer 122 to a structure.

As illustrated in FIG. 3, the retainer 122 can comprise the second surface 126 extending from the first surface 124, and the third surface 130 extending from the first surface 124. For example, the first surface 124 can extend from the second surface 126 to the third surface 130 and the first, second, and third surfaces 124, 126, and 130, respectively, can form a C-shape configured to receive the sleeve 102. In various non-limiting embodiments, the first surface 124 and the second surface 126 are substantially perpendicular to one another, and the first surface 124 and the third surface 130 are substantially perpendicular to one another. In various embodiments, the second surface 126 may be substantially parallel to the third surface 130.

The sleeve 102 can comprise a single component or multiple components. For example, as illustrated in FIGS. 1-3, the sleeve 102 may comprises a first component 103 and a clip 140. The first component 103 can comprise a first sleeve end 104, a second sleeve end 106, an elongate portion 108 intermediate the first sleeve end 104 and the second sleeve end 106, and an inner surface 116. The elongate portion 108 can define a longitudinal axis, A₁, of the sleeve 102. The inner surface 116 extends from the first sleeve end 104 towards the second sleeve end 106. In various non-limiting embodiments, the inner surface 116 extends from the first sleeve end 104 through the elongate portion 108 and through the second sleeve end 106. The inner surface 116 can define a sleeve cavity 110 that extends into the elongate portion 108 from the first sleeve end 104 towards the second sleeve end 106. In various non-limiting embodiments, the sleeve cavity 110 extends completely through the elongate portion 108 such that the sleeve 102 is generally tubular when the first sleeve end 104 and the second sleeve end 106 are open.

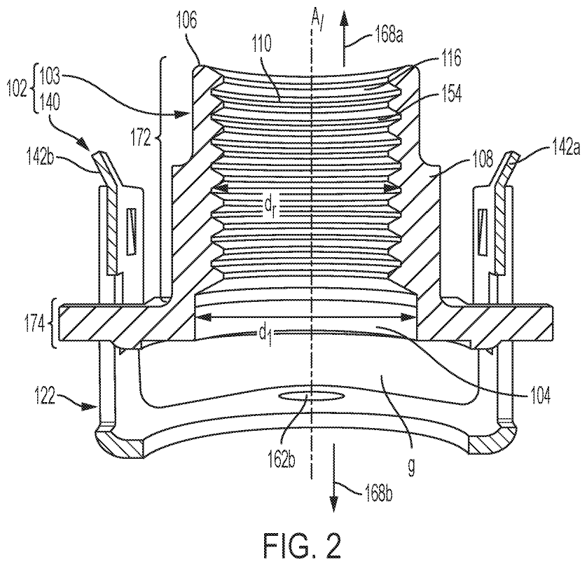

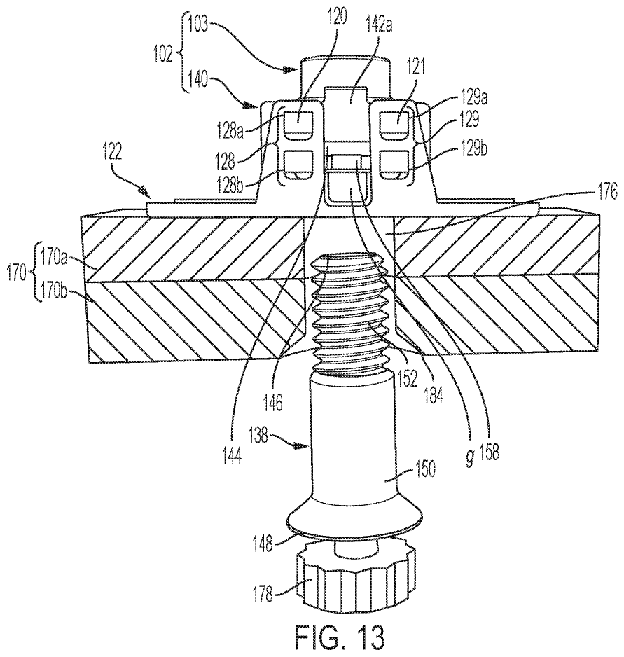

Referring to FIG. 2, the sleeve cavity 110 of the sleeve 102 can be configured to at least partially receive a shank of a pin therein (e.g., pin 138 in FIG. 13). The sleeve 102, including the inner surface 116, can be configured to retain the pin 138, such as, for example, by friction fit. The inner surface 116 can comprise a threaded portion 154 suitable to engage threads on a shank of the pin 138.

As illustrated in FIG. 2, in certain non-limiting embodiments, the inner surface 116 of the sleeve 102 can comprise a first portion 172 extending along the longitudinal axis, A₁, and comprising a threaded portion 154 having a root diameter, dᵣ. The inner surface 116 can further comprise a second portion 174 extending along the longitudinal axis comprising a cylindrical shape defining a first diameter, d₁. The first portion 172 of the inner surface 116 can be disposed intermediate the second portion 174 and the second sleeve end 106. The first diameter, d₁, can be greater than the root diameter, dᵣ of the threads, such that a forming tool can enter the second portion 174 without damaging the threaded portion 154 in the first portion 172. The second portion 174 can enable installment of the multi-piece fastener 100 onto the structure 170 with the sleeve 102 in the second position illustrated in FIG. 4 or in various non-limiting embodiments where ratchet features may not be present. In certain embodiments, the first diameter, d₁, can be at least 10% greater than the root diameter, dᵣ, such as, for example, at least 20% greater than the root diameter, dᵣ.

The sleeve 102 can comprise one or more ratchet features, and the retainer 122 can comprise one or more corresponding ratchet features, such that the respective ratchet features are configured to enable movement of the sleeve 102 from the first position, as illustrated in FIG. 1, to the second position, as illustrated in FIG. 4, and inhibit movement of the sleeve 102 from the second position back to the first position. The sleeve 102 can comprise one or more ratchet features coupled to the elongate portion 108. For example, the one or more ratchet features can be integral with the sleeve 102 (e.g., integral with the elongate portion 108) or, as illustrated in FIGS. 1-3, the clip 140 can comprise ratchet features 120-121 and 134-135 and the clip 140 can be mechanically coupled to the elongate portion 108.

In various embodiments, the retainer 122 can comprise one or more ratchet features on the second surface 126 and/or the third surface 130. For example, as illustrated in FIG. 3, the second surface 126 comprises ratchet features 128-129, and the third surface 130 can comprise ratchet features 132-133.

Referring to FIG. 3, the ratchet features 120-121, 128-129, and 132-135 can comprise a shape suitable for retaining the sleeve 102 in a desired position with respect to the retainer 122. For example, the ratchet features 120-121, 128-129, and 132-135 can comprise a physical feature configured to engage with a corresponding ratchet feature and selectively inhibit or enable the movement of the sleeve 102 along the longitudinal axis, A₁, depending on the force applied to the longitudinal axis, A₁, of the sleeve 102. For example, referring to FIGS. 1-2, the ratchet features 120-121, 128-129, and 132-135 are configured to engage one another in order to inhibit the sleeve 102 from moving along the longitudinal axis, A₁, when a force less than a predetermined force is applied to the longitudinal axis, A₁, in direction 168b. Ratchet features 120-121, 128-129, and 132-135 are configured to enable the sleeve 102 to the move along the longitudinal axis, A₁, in direction 168b when a force equal to or greater than the predetermined force is applied to the longitudinal axis, A₁.

Referring to FIG. 3, the ratchet feature 120 can correspond with and be configured to engage ratchet feature 128; ratchet feature 121 can correspond with and be configured to engage ratchet feature 129; ratchet feature 134 can correspond with and be configured to engage ratchet feature 132; and ratchet feature 135 can correspond with and be configured to engage ratchet feature 133. The ratchet features 120-121, 128-129, and 132-135, can individually comprise at least one of a bore, a protrusion, a tooth, and other ratchet feature.

As illustrated in FIGS. 1-3, the ratchet features 120-121 and 134-134 are protrusions and each of the ratchet features 128-129 and 132-133 comprises two bores. For example, ratchet feature 128 comprises first bore 128a and second bore 129a; ratchet feature 129 comprises first bore 129a and second bore 129b; ratchet feature 132 comprises first bore 132a and second bore 132b; and ratchet feature 133 comprises first bore 133a and second bore 133b.

Each of the first bores 128a, 129a, 132a, and 133a can be substantially in the same plane, and each of the second bores 128b, 129b, 132b, and 133b can be substantially in the same plane.

The corresponding ratchet features 120-121, 128-129, and 132-135 are configured to engage one another in order to inhibit the sleeve 102 from moving along the longitudinal axis, A₁, when a first force, which is less than a predetermined force, is applied to the longitudinal axis, A₁, in direction 168b. For example, FIG. 1 illustrates the sleeve 102 in the first position wherein: the ratchet feature 120 is engaged with and extends into the first bore 128a of the ratchet feature 128; the ratchet feature 121 is engaged with and extends into the first bore 129a of the ratchet feature 129; the ratchet feature 134 is engaged with and extends into the first bore 132a of the ratchet feature 132; and the ratchet feature 135 is engaged with and extends into the first bore 133a of the ratchet feature 133.

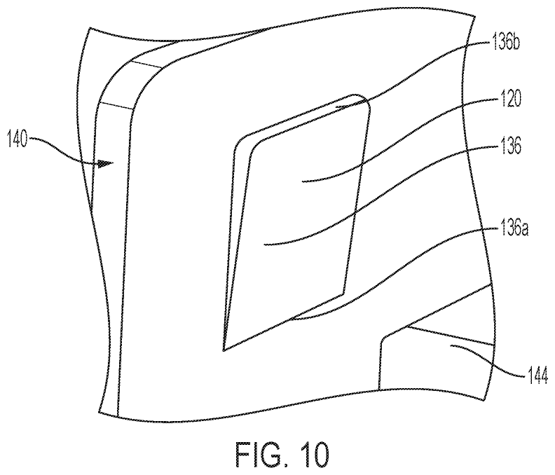

In various embodiments, the ratchet features 120-121 and 134-135 can comprise a tapered surface 136. For example, as illustrated in FIG. 10, the tapered surface 136 of ratchet feature 120 can be substantially flush with the second surface 126 at a first end 136a of the tapered surface 136. The tapered surface 136 can extend away from the second surface 126 as one moves along the longitudinal axis, A₁, towards a second end 136b of the tapered surface. The tapered surface 136 of each ratchet feature 120-121 and 134-135 can enable movement of the respective ratchet feature 120-121 and 134-135 from the first bore 128a, 129a, 132a, and 133a of the respective ratchet feature 128, 129, 132, and 133, to the second bore 128b, 129b, 132b, and 133b of the respective ratchet feature 128, 129, 132, and 133. This movement can occur because the first end 136a of the tapered surface 136 enables the ratchet features 120-121 and 134-135 to disengage the respective first bore 128a, 129a, 132a, and 133a upon application of at least the predetermined force along longitudinal axis, A₁, in direction 168b. For example, the tapered surface 136 can act as a wedge, such that the sleeve 102 can slide along the retainer 122 from the first position, as illustrated in FIG. 1, to the second position as illustrated in FIG. 4.

The tapered surface 136 of each ratchet feature 120-121 and 134-135 can inhibit movement of the respective ratchet feature 120-121 and 134-145 from the second bore 128b, 129b, 132b, and 133b of the respective ratchet feature 128, 129, 132, and 133 to the first bore 128a, 129a, 132a, and 133a of the respective ratchet feature 128, 129, 132, and 133. This movement can be inhibited because the second end 136b of the tapered surface 136 engages the ratchet features 120-121 and 134-135 to inhibit the respective ratchet feature 128, 129, 132, and 133 from traveling along the longitudinal axis, A₁, in the direction 168a. For example, the tapered surface 136 can act as a stopper, such that the sleeve 102 cannot slide along the retainer 122 from the second position, as illustrated in FIG. 4, to the first position, as illustrated in FIG. 1.

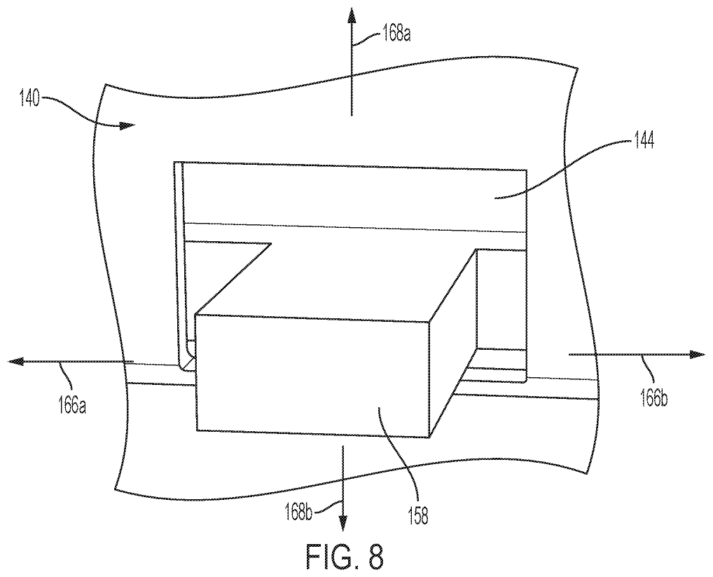

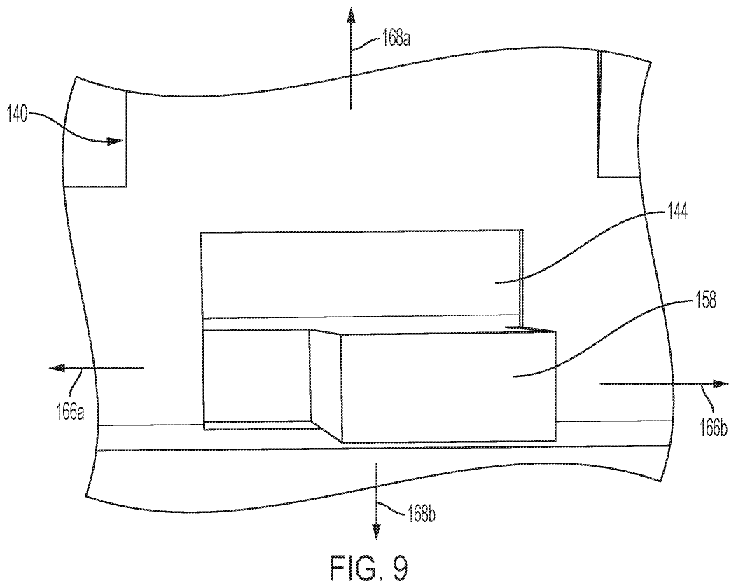

As illustrated in FIG. 1, the clip 140 can comprise a slot 144 and the first component 103 can comprise a protrusion 158 configured to extend into the slot 144 and slidably engage with the slot 144. Referring to FIG. 8, the protrusion 158 and the slot 144 can be sized to enable movement of the protrusion 158 in various directions, 166a, 166b, 168a, 168b, within the slot 144, which can provide tolerance to the installation location of the multi-piece fastener 100 on a structure. For example, during installation of the multi-piece fastener 100 on a structure, a pin (e.g., pin 138 as illustrated with respect to FIG. 13) can be introduced into the sleeve cavity 110 in order to engage the sleeve 102. The sleeve 102 has tolerance in various direction, 166a, 166b, 168a, and 168b, to allow movement of the sleeve in the directions 166a, 166b, 168a, and 168b, thereby enabling the pin 138 to engage the sleeve 102 even if the pin 138 and the sleeve 102 are slightly out of alignment. As shown in FIG. 9, the protrusion 158 of the sleeve 102 can be moved to a different position while the sleeve 102 is in the second position than when the sleeve 102 is in the first position as illustrated in FIG. 8.

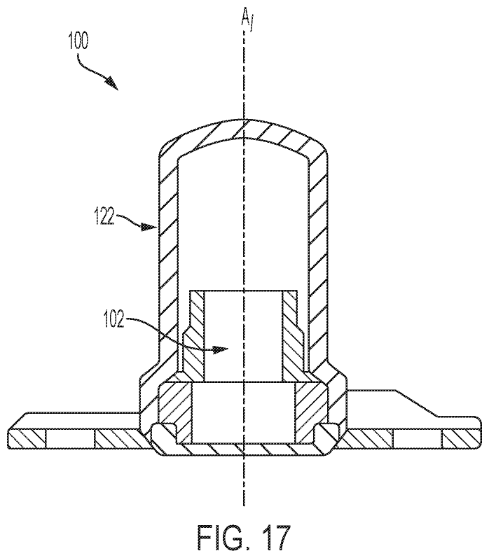

Referring to FIG. 17, in various non-limiting embodiments, the retainer 122 can be configured to form an enclosed cavity with the structure wherein the sleeve 102 can be enclosed by the retainer 122. In such a configuration, the sleeve 102 may not be accessible during installation of the multi-piece fastener 100. Alternatively, in certain non-limiting embodiments, the sleeve 102 can be partially enclosed by the retainer 122 such that, for example, the retainer 122 can be partially accessible during installation.

Referring yet again to FIG. 3, the clip 140 can be flexible to enable movement of the ratchet features 128-129 and 132-133 and, therefore, allow the sleeve 102 to move from the second position, as illustrated in FIG. 4, to the first position, as illustrated in FIG. 1 and/or to remove the clip 140 from the retainer 122. For example, the clip 140 can comprise flanges 142a-142b. The flanges 142a-142b of the clip 140 can be configured such that, when the flanges 142a-142b are squeezed towards one another, ratchet features 120-121 and/or 134-135 disengage from ratchet feature 128-129 and/or 132-133, respectively. Upon disengagement of ratchet feature 120-121 and/or 134-135, and provided a pin is not engaged with the sleeve 102, the sleeve 102 can be moved along the longitudinal axis, A₁, in the direction 168b.

The flanges 142a-142b of the clip 140 can be configured such that, when the flanges 142a-142b are flexed away from one another the first component 103 can be installed into and/or removed from the clip 140. For example, the flanges 142a-142b may be flexed such that the protrusions 158 disengage the slots 144 and the first component 103 can be removed from the clip 140.

As described above, the multi-piece fastener 100 can be installed in various structures prior to forming a bore in the structure. In certain non-limiting embodiments, the structure can comprise two or more layers of material. For example, as illustrated in FIG. 11, the structure 170 can comprise a first layer 170a and a second layer 170b, which may comprise the same material or different materials. The first layer 170a can be positioned intermediate the second layer 170b and the retainer 122 when the multi-piece fastener 100 is installed. In various non-limiting embodiments, the second layer 170b is adjacent to or contacts the pin 138.

The structure 170 can comprise, for example, at least one of a metal, a metal alloy, a composite material, or another suitable material. For example, in certain non-limiting embodiments, the structure 170 can comprise one or more of aluminum, an aluminum alloy, titanium, a titanium alloy, nickel, a nickel alloy, iron, an iron alloy, and a carbon fiber composite material. In various non-limiting embodiments, the structure 170 comprises aluminum and/or an aluminum alloy, such as, for example, a 7075 aluminum alloy. In various non-limiting embodiments, the structure 170 can be configured as, or as a part or region of, at least one of an aerospace component or structure, an automotive component or structure, a transportation component or structure, a building and construction component or structure, or another component or structure.

To install the multi-piece fastener 100, the retainer 122 of the multi-piece fastener can be coupled to the structure 170. For example, the retainer 122 can be coupled to the structure 170 by at least one of a fastener, by friction fitting the retainer 122 to the structure 170 with a pin, by adhering the retainer 122 to the structure 170 with adhesive, and using another attachment technique. As illustrated in FIG. 11, the retainer 122 has been coupled to the structure 170 by rivets 180, and the sleeve 102 is in the first position relative to the retainer 122. The sleeve 102 can be inserted into the retainer 122 such that the ratchet features 120-121 and 134-135 are engaged with the first bores 128a, 129a, 132a, and 133a prior to coupling the retainer 122 to the structure 170 or after the retainer 122 has been coupled to the structure 170.

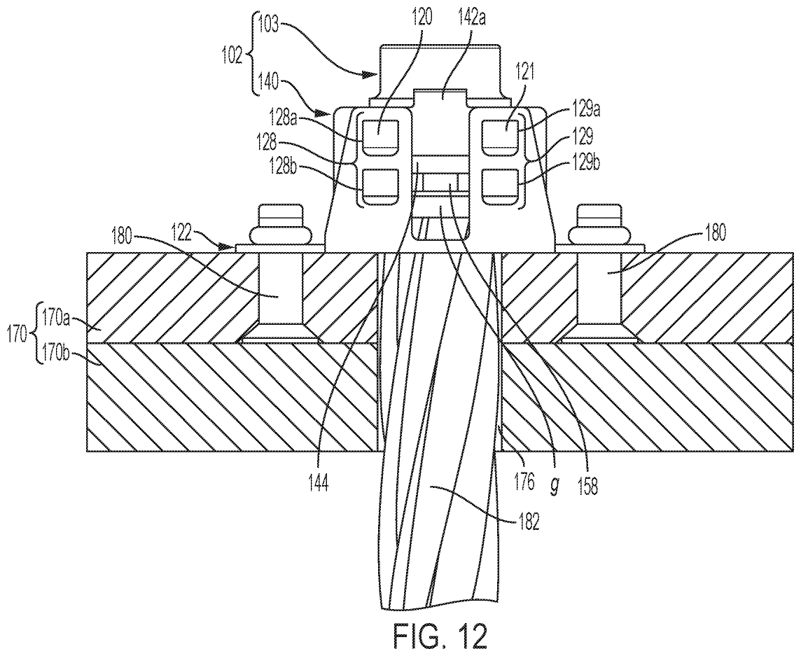

After coupling the retainer 122 to the structure 170, a bore can be formed in the structure that is substantially aligned with the sleeve 102. For example, referring to FIG. 12, a bore 176 has been created in the structure 170 after coupling the retainer 122 to the structure 170 by a forming tool 182. As illustrated, the forming tool 182 can traverse through the structure 170 and at least partially into the gap, g. The gap, g, can inhibit damage to the sleeve 102.

In various non-limiting embodiments in which the retainer 122 does not include a bore upon coupling to the structure 170 as illustrated in FIG. 7, the forming tool 182 can create a bore in the retainer 122 while creating the bore 176 in the structure 170. After formation of the bore 176, the forming tool 182 can be removed. Optionally, referring to FIG. 13, a chamfer 184 or other suitable feature may be formed in the second layer 170b of the structure 170 such that a head of a fastener can be countersunk into the structure 170.

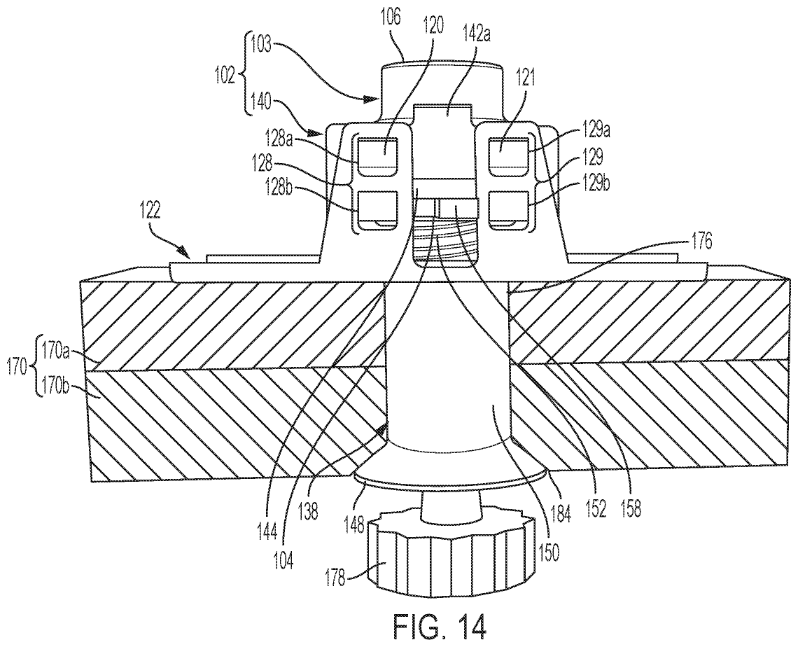

A pin 138 can be positioned in alignment with the bore 176 on the second layer 170b of the structure 170 and inserted into the bore 176. The pin 138 can be inserted until the pin 138 enters the sleeve cavity 110 and engages the sleeve 102, as illustrated in FIG. 14. The pin 138 can comprise a first pin end 146, a second pin end 148, and a shank 150. The shank 150 can define a longitudinal axis of the pin 138, extending from the first pin end 146 to the second pin end 148. The longitudinal axis of the pin 138 may be coextensive with the longitudinal axis, A₁, of the sleeve 102. The shank 150 can comprise a shape that can be received within the sleeve cavity 110 of the sleeve 102. The shank 150 can be intermediate the first pin end 146 and the second pin end 148. The shank 150 can be dimensioned so that it can be inserted and extend at least partially into the sleeve cavity 110.

In various non-limiting embodiments, the shank 150 comprises a threaded portion 152 complimentary to the threaded portion 154 of the inner surface 116 of the sleeve 102. The threaded portions 152, 154 may comprises various suitable threads, such as, for example, a right handed thread, a left handed thread, a single-start lead thread, a multi-start lead thread, and/or other thread type.

Referring to FIG. 14, the shank 150 of the pin has been inserted into the sleeve cavity 110 of the sleeve 102 and the threaded portions 152 and 154 have been engaged with one another. As illustrated, the first pin end 146 is disposed proximal to the second sleeve end 106, and the second pin end 148 is disposed adjacent the second layer 170b. As shown, the second pin end 148 can inhibit the pin 138 from passing completely through a bore in the structure and can contact the structure or other feature to inhibit the pin 138 from extending beyond a predetermined distance. In various non-limiting embodiments, the second pin end 148 can be tapered and/or configured to mount flush with the structure 170.

As illustrated in FIG. 14, the sleeve 102 is in the first position relative to the retainer 122. The pin 138 can continue to be installed into the sleeve 102 (e.g., rotated about the longitudinal axis, A₁) such that a force is applied to the sleeve 102 along the longitudinal axis, A₁, that is equal to or greater than a predetermined force. The force urges the sleeve 102 towards the first surface 124 of the retainer 122 and reduces the gap, g.

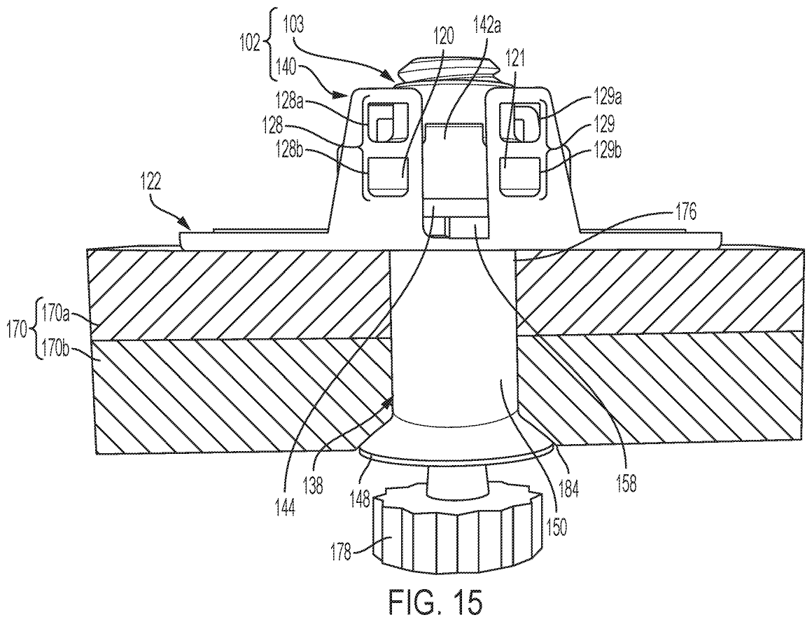

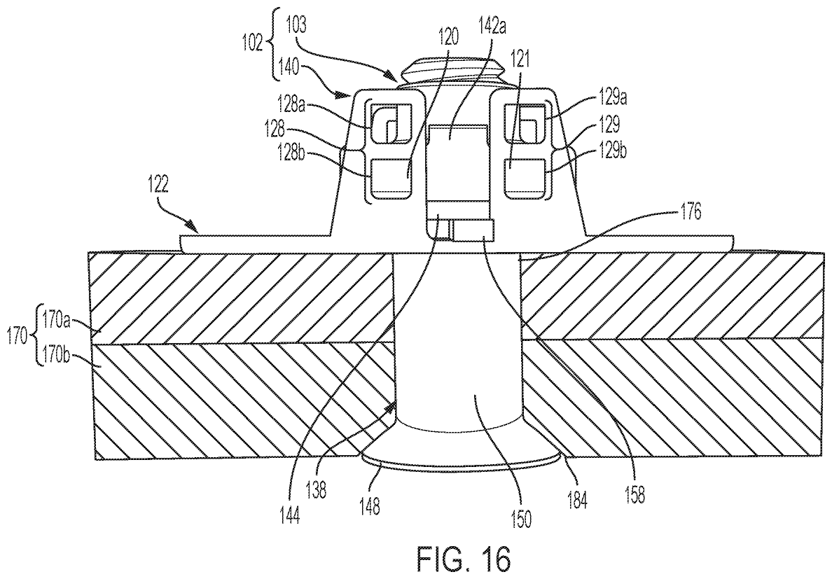

As illustrated in FIG. 15, the sleeve 102 has been urged into the second position by the force applied along the longitudinal axis, A₁, in direction of the structure 170. The ratchet features 120-121 and 134-135 have moved from the first bores 128a, 129a, 132a, and 133a to the second bores 128b, 129b, 132b, and 133b, thereby inhibiting movement of the sleeve 102 from the second position as illustrated in FIG. 15 back to the first position as illustrated in FIG. 14. In various non-limiting embodiments, the sleeve 102 may stay in the first position even if the pin 138 is removed from the sleeve 102. Referring to FIG. 16, the installation of the pin 138 into the sleeve 102 can decrease the width of a gap, if present, between the first layer 170a and the second layer 170b of the structure 170 and forcibly contact the second pin end 148 of the pin 138 with the structure 170. In various non-limiting embodiments, the head portion 178 can be configured to fracture upon application of an installation force equal to or greater than a threshold force. For example, as illustrated in FIG. 16, the head portion 178 of the pin 138 has been fractured and removed from the pin 138 such that the pin 138 is flush with the second layer 170b of the structure 170.

The multi-piece fastener 100 can be sized as appropriate for the intended application. For example, in certain non-limiting embodiments, the diameter of the shank 150 can be in a range of 0.06 inch to 4 inches, and the sleeve 102 can be sized to receive the shank 150.

The multi-piece fastener 100, including the sleeve 102 and the retainer 122, can comprise any suitable material, such as, for example, a metal, a metal alloy, a polymer, a composite material, or another suitable material. For example, in various non-limiting embodiments, the multi-piece fastener 100 can comprise at least one of aluminum, an aluminum alloy, titanium, a titanium alloy, nickel, a nickel alloy, iron, an iron alloy, and a carbon fiber composite material.

Various aspects of non-limiting embodiments of inventions according to the present disclosure include, but are not limited to, the aspects listed in the following numbered clauses.

Clause 1. A multi-piece fastener comprising:
a sleeve comprising
   an elongate portion defining a longitudinal axis and comprising an inner surface, the inner surface defining a sleeve cavity, and
   a first ratchet feature coupled to the elongate portion; and
a retainer comprising
   a first surface, and
   a second surface extending from the first surface and comprising a second ratchet feature, wherein the second ratchet feature is configured to engage the first ratchet feature to thereby
      inhibit the sleeve from moving along the longitudinal axis when a first force applied along the longitudinal axis to the sleeve is less than a predetermined force, and
      enable the sleeve to move along the longitudinal axis when a second force applied along the longitudinal axis to the sleeve is equal to or greater than the predetermined force.

Clause 2. The multi-piece fastener of clause 1, wherein when the second force applied along the longitudinal axis to the sleeve is at least the predetermined force, the sleeve is configured to move from a first position to a second position, and the second position is closer to the first surface than the first position.

Clause 3. The multi-piece fastener of clause 2, wherein each of the first ratchet feature and the second ratchet feature, individually, comprises at least one of a bore, a protrusion, and a tooth.

Clause 4. The multi-piece fastener of any of clauses 2-3, wherein:
the first ratchet feature comprises a protrusion;
the second ratchet feature comprises a first bore configured to receive the protrusion and a second bore configured to receive the protrusion; and
the protrusion is configured to be received by the first bore when the sleeve is in the first position and is configured to be received by the second bore when the sleeve is in the second position.

Clause 5. The multi-piece fastener of clause 4, wherein the protrusion comprises a tapered surface enabling the protrusion to move from the first bore to the second bore and inhibiting the protrusion from moving from the second bore to the first bore.

Clause 6. The multi-piece fastener of any of clauses 1-5, further comprising:
a third surface extending from the first surface;
wherein the first surface extends from the third surface to the second surface, the third surface comprises a third ratchet feature, and the sleeve further comprises a fourth ratchet feature coupled to the elongate portion and configured to engage the third ratchet feature.

Clause 7. The multi-piece fastener of clause 6, wherein the first surface is a continuous surface from the second surface to the third surface.

Clause 8. The multi-piece fastener of any of clauses 6-7, wherein:
the second surface comprises a fifth ratchet feature and the sleeve further comprises a sixth ratchet feature coupled to the elongate portion and configured to engage the fifth ratchet feature; and
the third surface comprises a seventh ratchet feature, and the sleeve further comprises am eighth ratchet feature coupled to the elongate portion and configured to engage the seventh ratchet feature Clause 9. The multi-piece fastener of any of clauses 1-6 and 8, wherein the first surface of the retainer comprises a bore configured to receive a pin, wherein the bore is substantially aligned with the longitudinal axis of the elongate portion.

Clause 10. The multi-piece fastener of any of clauses 1-9, wherein the sleeve comprises at least two components comprising a first component comprising the elongate portion and a clip comprising the first ratchet feature.

Clause 11. The multi-piece fastener of clause 10, wherein the clip is positioned intermediate the first component and the retainer.

Clause 12. The multi-piece fastener of clause 11, wherein the clip comprises a slot and the first component comprises a protrusion slidably engaged with the slot.

Clause 13. The multi-piece fastener of any of clauses 1-12, further comprising a pin, wherein the pin comprises:
a first pin end;
a second pin end; and
a shank extending from the first pin end to the second pin end, and comprising a first threaded portion;
wherein the inner surface of the sleeve comprises a second threaded portion configured to engage the first threaded portion.

Clause 14. The multi-piece fastener of any of clauses 1-13, wherein the sleeve is positioned within the retainer and the retainer is configured to enable the formation of an enclosed cavity with a structure.

Clause 15. The multi-piece fastener of any of clauses 1-14, wherein the first surface of the retainer is configured to couple with a structure by at least one of a fastener, a pin, and an adhesive.

Clause 16. A multi-piece fastener comprising:
a sleeve comprising
   a first sleeve end,
   a second sleeve end, and
   an elongate portion extending from the first sleeve end to the second sleeve end and defining a longitudinal axis, the elongate portion comprising an inner surface defining a sleeve cavity, and the inner surface comprising
      a first portion extending along the longitudinal axis and comprising threads having a root diameter, and
      a second portion extending along the longitudinal axis and comprising a cylindrical shape defining a first diameter, wherein the first diameter is greater than the root diameter of the threads and the first portion is disposed intermediate the second portion and the second sleeve end; and
a retainer comprising
   a first surface, and
   a second surface extending from the first surface, wherein the second surface is coupled to the sleeve.

Clause 17. The multi-piece fastener of clause 16, wherein the first diameter is at least 10% greater than the root diameter.

Clause 18. A method comprising:
coupling a retainer of a multi-piece fastener to a structure, wherein the multi-piece fastener comprises
   a sleeve comprising
      an elongate portion defining a longitudinal axis and comprising an inner surface, the inner surface defining a sleeve cavity, and
      a first ratchet feature coupled to the elongate portion; and
   the retainer comprising
      a first surface, and
      a second surface extending from the first surface and comprising a second ratchet feature, wherein the second ratchet feature is configured to engage the first ratchet feature;
forming a bore in the structure after coupling the retainer to the structure;
inserting a pin of the multi-piece fastener through the bore and into the sleeve cavity of the sleeve; and
engaging the pin with the inner surface of the sleeve to move the sleeve along the longitudinal axis towards the structure when a force applied along the longitudinal axis is equal to or greater than a predetermined force.

Clause 19. The method of clause 18, wherein coupling the retainer to the structure comprises at least one of fastening the retainer to the structure with a fastener, friction fitting the retainer to the structure with a pin, and adhering the retainer to the structure with an adhesive.

Clause 20. The method of any of clauses 18-19, wherein:
the first ratchet feature comprises a protrusion and the second ratchet feature comprises at a first bore configured to receive the protrusion and a second bore configured to receive the protrusion; and
engaging the pin with the inner surface of the sleeve to move the sleeve along the longitudinal axis towards the structure comprises moving the protrusion from the first bore to the second bore.

Clause 21. A method comprising:
coupling a retainer of the multi-piece fastener of any of clauses 1-15 to a structure;
forming a bore in the structure after coupling the retainer to the structure;
inserting a pin of the multi-piece fastener through the bore and into the sleeve cavity of the sleeve; and
engaging the pin with the inner surface of the sleeve to move the sleeve along the longitudinal axis towards the structure when a force applied along the longitudinal axis is equal to or greater than a predetermined force.

Clause 22. A method comprising:
coupling a retainer of the multi-piece fastener of any of clause 16 to a structure;
forming a bore in the structure after coupling the retainer to the structure;
inserting a pin of the multi-piece fastener through the bore and into the sleeve cavity of the sleeve; and
engaging the pin with the inner surface of the sleeve.

One skilled in the art will recognize that the fastening sleeves, multi-piece fasteners, structures, methods, operations/actions, and objects described herein, and the accompanying discussion, are non-limiting examples presented for the sake of conceptual clarity, and that various modifications to the disclosed configurations are contemplated. Consequently, as used herein, the specific examples/embodiments set forth, and the accompanying discussion, are intended to be representative of their more general classes. In general, use of any specific exemplar is intended to be representative of its class and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

Any references herein to “various embodiments”, “some embodiments”, “one embodiment”, “an embodiment”, a “non-limiting embodiment”, or like phrases mean that a particular feature, structure, or characteristic described in connection with the example is included in at least one embodiment. Thus, appearances of the phrases “in various embodiments”, “in some embodiments”, “in one embodiment”, “in an embodiment”, “in a non-limiting embodiment”, or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a”, “an”, and “the”, as used herein, are intended to include “at least one” or “one or more”, unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

What is claimed is:

1. A multi-piece fastener comprising:
a sleeve comprising
an elongate portion defining a longitudinal axis and comprising an inner surface, the inner surface defining a sleeve cavity, and
a first ratchet feature coupled to the elongate portion; and
a retainer comprising
a first surface, and
a second surface extending from the first surface and comprising a second ratchet feature, wherein the second ratchet feature is configured to engage the first ratchet feature to thereby
inhibit the sleeve from moving along the longitudinal axis when a first force applied along the longitudinal axis to the sleeve is less than a predetermined force, and
enable the sleeve to move along the longitudinal axis when a second force applied along the longitudinal axis to the sleeve is equal to or greater than the predetermined force.

2. The multi-piece fastener of claim 1, wherein when the second force applied along the longitudinal axis to the sleeve is at least the predetermined force, the sleeve is configured to move from a first position to a second position, and the second position is closer to the first surface than the first position.

3. The multi-piece fastener of claim 2, wherein each of the first ratchet feature and the second ratchet feature, individually, comprises at least one of a bore, a protrusion, and a tooth.

4. The multi-piece fastener of claim 2, wherein:
the first ratchet feature comprises a protrusion;
the second ratchet feature comprises a first bore configured to receive the protrusion and a second bore configured to receive the protrusion; and
the protrusion is configured to be received by the first bore when the sleeve is in the first position and is configured to be received by the second bore when the sleeve is in the second position.

5. The multi-piece fastener of claim 4, wherein the protrusion comprises a tapered surface enabling the protrusion to move from the first bore to the second bore and inhibiting the protrusion from moving from the second bore to the first bore.

6. The multi-piece fastener of claim 1, further comprising:
a third surface extending from the first surface;
wherein the first surface extends from the third surface to the second surface, the third surface comprises a third ratchet feature, and the sleeve further comprises a fourth ratchet feature coupled to the elongate portion and configured to engage the third ratchet feature.

7. The multi-piece fastener of claim 6, wherein the first surface is a continuous surface from the second surface to the third surface.

8. The multi-piece fastener of claim 6, wherein:
the second surface comprises a fifth ratchet feature and the sleeve further comprises a sixth ratchet feature coupled to the elongate portion and configured to engage the fifth ratchet feature; and
the third surface comprises a seventh ratchet feature, and the sleeve further comprises am eighth ratchet feature coupled to the elongate portion and configured to engage the seventh ratchet feature 9. The multi-piece fastener of claim 1, wherein the first surface of the retainer comprises a bore configured to receive a pin, wherein the bore is substantially aligned with the longitudinal axis of the elongate portion.

10. The multi-piece fastener of claim 1, wherein the sleeve comprises at least two components comprising a first component comprising the elongate portion and a clip comprising the first ratchet feature.

11. The multi-piece fastener of claim 10, wherein the clip is positioned intermediate the first component and the retainer.

12. The multi-piece fastener of claim 11, wherein the clip comprises a slot and the first component comprises a protrusion slidably engaged with the slot.

13. The multi-piece fastener of claim 1, further comprising a pin, wherein the pin comprises:
a first pin end;
a second pin end; and
a shank extending from the first pin end to the second pin end, and comprising a first threaded portion;
wherein the inner surface of the sleeve comprises a second threaded portion configured to engage the first threaded portion.

14. The multi-piece fastener of claim 1, wherein the sleeve is positioned within the retainer and the retainer is configured to enable the formation of an enclosed cavity with a structure.

15. The multi-piece fastener of claim 1, wherein the first surface of the retainer is configured to couple with a structure by at least one of a fastener, a pin, and an adhesive.

16. A multi-piece fastener comprising:
a sleeve comprising
a first sleeve end,
a second sleeve end, and
an elongate portion extending from the first sleeve end to the second sleeve end and defining a longitudinal axis, the elongate portion comprising an inner surface defining a sleeve cavity, and the inner surface comprising
a first portion extending along the longitudinal axis and comprising threads having a root diameter, and
a second portion extending along the longitudinal axis and comprising a cylindrical shape defining a first diameter, wherein the first diameter is greater than the root diameter of the threads and the first portion is disposed intermediate the second portion and the second sleeve end; and
a retainer comprising
a first surface, and
a second surface extending from the first surface, wherein the second surface is coupled to the sleeve.

17. The multi-piece fastener of claim 16, wherein the first diameter is at least 10% greater than the root diameter.

18. A method comprising:
coupling a retainer of a multi-piece fastener to a structure, wherein the multi-piece fastener comprises
a sleeve comprising
an elongate portion defining a longitudinal axis and comprising an inner surface, the inner surface defining a sleeve cavity, and
a first ratchet feature coupled to the elongate portion; and
the retainer comprising
a first surface, and
a second surface extending from the first surface and comprising a second ratchet feature, wherein the second ratchet feature is configured to engage the first ratchet feature;
forming a bore in the structure after coupling the retainer to the structure;
inserting a pin of the multi-piece fastener through the bore and into the sleeve cavity of the sleeve; and
engaging the pin with the inner surface of the sleeve to move the sleeve along the longitudinal axis towards the structure when a force applied along the longitudinal axis is equal to or greater than a predetermined force.

19. The method of claim 18, wherein coupling the retainer to the structure comprises at least one of fastening the retainer to the structure with a fastener, friction fitting the retainer to the structure with a pin, and adhering the retainer to the structure with an adhesive.

20. The method of claim 18, wherein:
the first ratchet feature comprises a protrusion and the second ratchet feature comprises at a first bore configured to receive the protrusion and a second bore configured to receive the protrusion; and
engaging the pin with the inner surface of the sleeve to move the sleeve along the longitudinal axis towards the structure comprises moving the protrusion from the first bore to the second bore.
